(19) United States
(12) Patent Application Publication
(10) Pub. No.: US 2015/0184797 A1
(43) Pub. Date: Jul. 2, 2015

(54) CONNECTING STRUCTURE

(71) Applicant: HON HAI PRECISION INDUSTRY CO., LTD., New Taipei (TW)

(72) Inventor: CHENG-HUA MA, New Taipei (TW)

(73) Assignee: HON HAI PRECISION INDUSTRY CO., LTD., New Taipei (TW)

(21) Appl. No.: 14/185,137

(22) Filed: Feb. 20, 2014

(30) Foreign Application Priority Data
Dec. 31, 2013 (CN) 2013107500738

(51) Int. Cl. F16M 13/02

(52) U.S. Cl. CPC F16M 13/02

(57) ABSTRACT

A connecting structure includes a ball joint bracket and a component bracket. The ball joint bracket includes a ball joint and the component bracket includes a housing space. The ball joint is rotatably received in the housing space, at least one protrusion is located on a selection one of an inner wall of the housing space and a surface of the ball joint. And at least one groove is located on the remaining one of the inner wall of the housing space and the surface of the ball joint, the at least one protrusion is slidably limited in the at least one groove.

### BACKGROUND

1. Technical Field

The present disclosure relates to a connecting structure, and more particularly to a connecting structure that can preciously control the trajectory of a bracket connected to the connecting structure.

2. Description of Related Art

A ball joint in a connection structure can make mechanical parts connected with the connection structure rotating freely at multiple angels. However, the existing connection structure with a ball joint cannot precisely control a track of the mechanical parts.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic perspective view of a connecting structure of an exemplary embodiment of the disclosure, wherein the connecting structure is used to adjust a position of an electronic device.

FIG. 2 is an exploded and isometric view of the connecting structure of FIG. 1.

FIG. 3 is an isometric view of a component bracket of the connecting structure of FIG. 2.

FIG. 4 is a cross sectional view taken along line B-B of the component bracket of FIG. 3.

FIG. 5 is a cross sectional view taken along line A-A of a ball joint structure of the connecting structure of FIG. 1.

FIG. 6 is a cross sectional view taken along line A-A of the ball joint of another structure of the connecting structure of FIG. 1.

### DETAILED DESCRIPTION

The disclosure is illustrated by way of example and not by way of limitation in the figures of the accompanying drawings in which like reference numerals indicate the same or similar elements. It should be noted that references to “an” or “one” embodiment in this disclosure are not necessarily to the same embodiment, and such references can mean “at least one.”

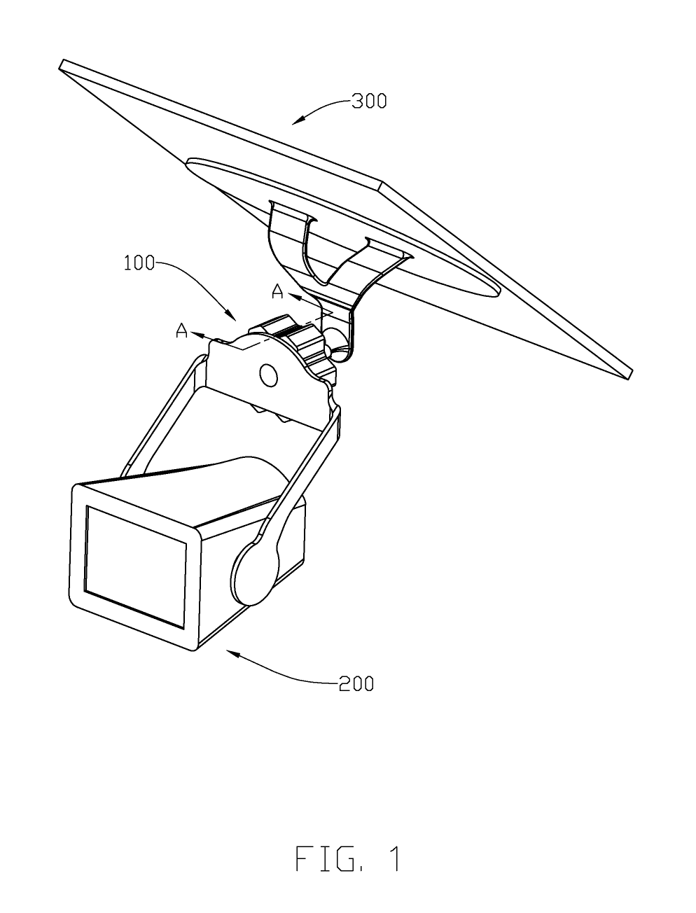

FIG. 1 shows a connecting structure 100 fixed on a board 300. The connecting structure 100 is configured for adjusting a position of an electronic device 200. The electronic device 200 is secured to one end of the connecting structure 100. In the embodiment, the electronic device 200 may be a car video recorder.

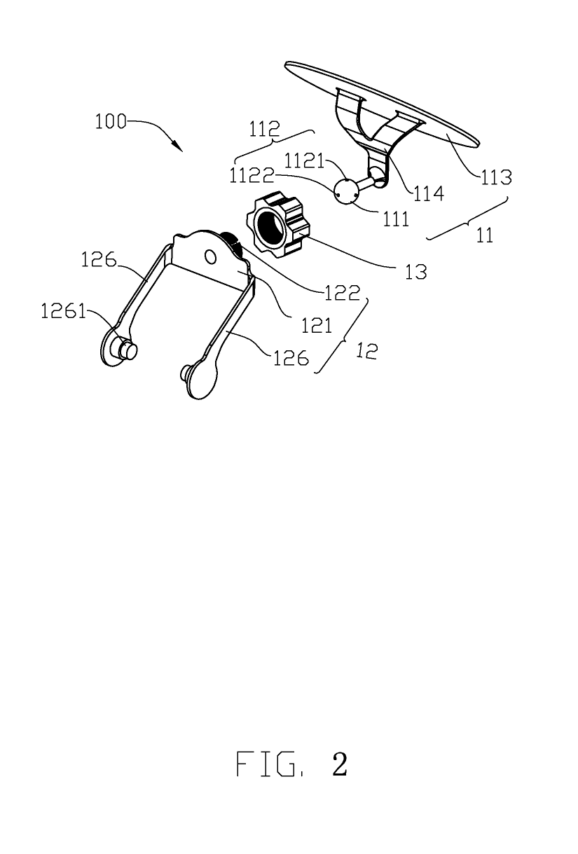

FIG. 2 shows that the connecting structure 100 includes a ball joint bracket 11, a component bracket 12 and a hexagon nut 13. The ball joint bracket 11 connects with the component bracket 12 by the hexagon nut 13.

The ball joint bracket 11 includes a ball joint 111, a locating seat 113 and a connecting arm 114. The ball joint 111 is located on one end of the connecting arm 114, and the locating seat 113 is located on another end of the connecting arm 114. The ball joint 111 includes a plurality of protrusions 112. The protrusions 112 are a selective one of a curved shape and a spherical shape. The protrusions 112 include a plurality of first protrusions 1121 and a second protrusion 1122. The first protrusions 1121 are located around the middle of the surface of the ball joint 111. The second protrusion 1122 is located on one end of the ball joint 111 far from the connecting arm 114. The ball joint bracket 11 is fixed on the board 300 through the locating seat 113, and the locating seat 113 is secured to the board 300 by screws.

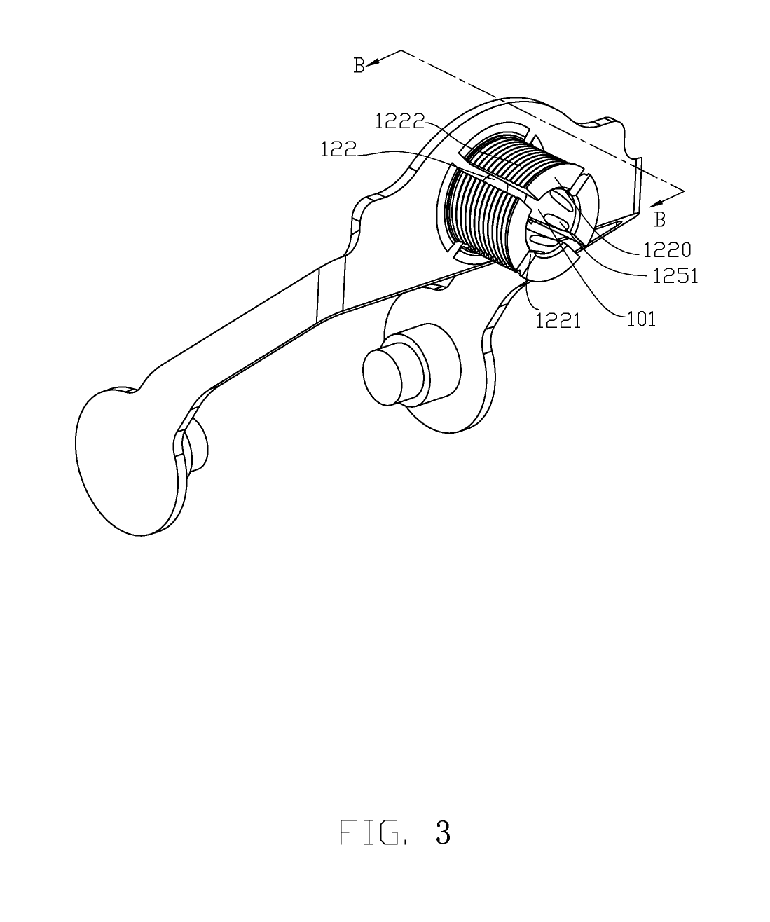

FIG. 2 and FIG. 3 show that the component bracket 12 defines a base 121, a joint base 122 and a support arm 126. The joint base 122 includes a plurality of flexible arms 1220 that are separated by gaps between the flexible arms 1220. In addition, the flexible arms 1220 extent from one side of the base 121. The flexible arms 1220 together with the base 121 form a cylindrical peripheral structure and a housing space 101. The ball joint 111 is received in the housing space 101.

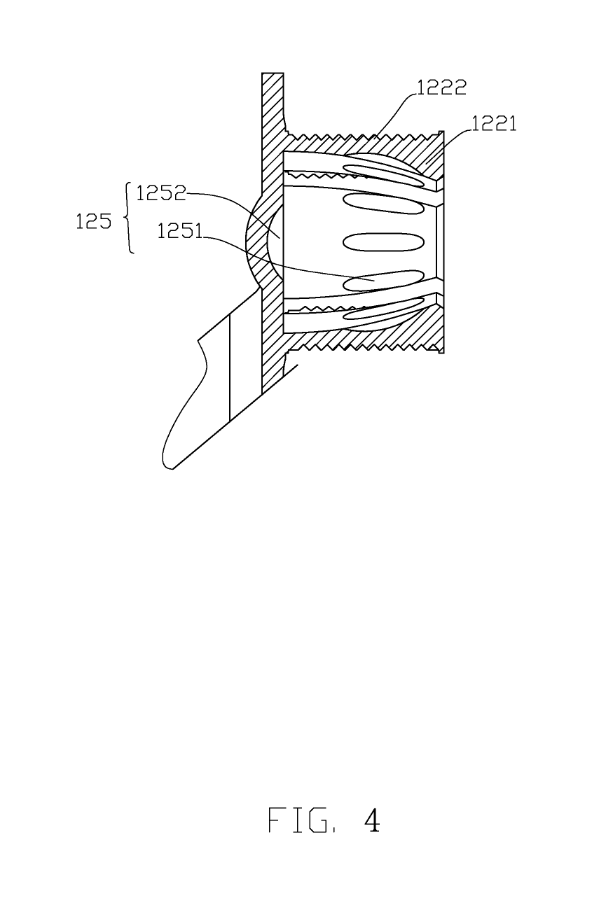

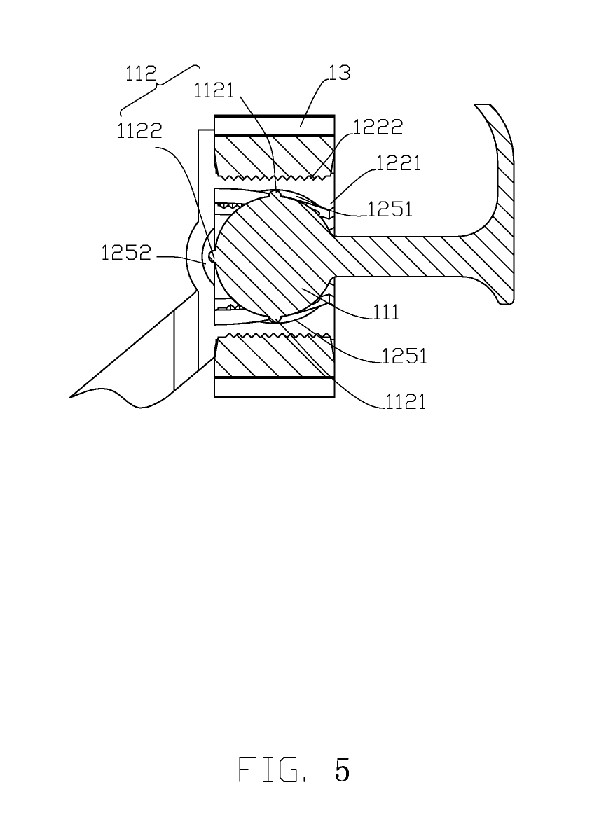

FIG. 4 and FIG. 5 show that a plurality of first grooves 1251 are located on the inner face of the flexible arms 1220 and a second groove 1252 is located on one side of the base 121 towards the housing space 101. The first grooves 1251 and the second groove 1252 cooperatively define the grooves 125 that match with the protrusions 112. The grooves 125 each are a concave arc shaped structure. The outer surface of each of the plurality of flexible arms 1220 forms thread portion 1222. The hexagon nut 13 is received in the thread portion 1222. Each of the plurality of flexible arms 1220 includes a stopper portion 1221. The stopper portion 1221 is located on one end of the flexible arm 1220 towards the housing space 101 to prevent the ball joint 111 from falling from the housing space 101. In addition, the support arm 126 extents from the other side of the base 121 and defines a holder 1261 for fixing the electronic device 200.

In assembly of the connecting structure 100, the ball joint 111 moves through the hexagon nut 13 and towards the housing space 101 to make the flexible arms 1220 be pressed and elastically deform to converge towards each other. When the ball joint 111 is completely into the housing space 101, the flexible arms 1220 rebound to restrict the ball joint 111 in the housing space 101. The first protrusions 1121 are slidably limited in the first grooves 1251, the second protrusion 1122 is slidably limited in the second groove 1252. Then, the hexagon nut 13 is tightened on the flexible arms 1220 and presses the flexible arms 1220 to the ball joint 111.

When the position of the electronic device 200 needs adjustment the hexagon nut 13 is unscrewed and component bracket 12 is moved. The joint base 122 is directionally rotated due to the protrusions 112 of the ball joint 111 being limited in the grooves 125 and slides to precisely control the trajectory of the component bracket 12. The first protrusions 1121 are limited in the first grooves 1251, the second protrusion 1122 is limited in the second groove 1252. When the electronic device 200 is driven by the component bracket 12 and reaches a preset position, the hexagon nut 13 is tightened to secure the connecting structure 100, thus completing the precise positioning.

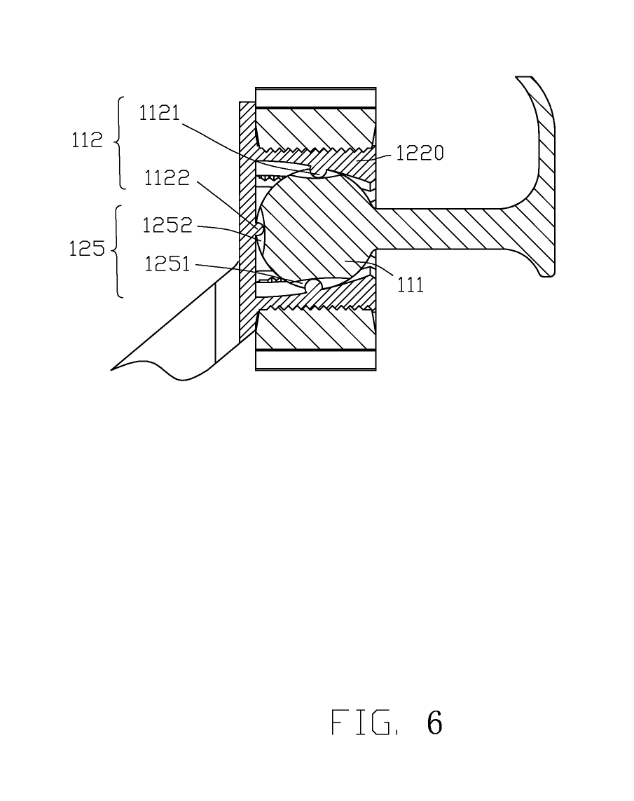

FIG. 6 shows that, in the embodiment, the protrusions 112 also can be located on the inner face of the flexible arms 1220 and the base 121 and correspondingly the grooves 125 are located on the surface of the ball joint 111.

In the embodiment, the connecting structure 100 may be made of plastic or metal to increase structural strength.

The connecting structure 100 with the protrusions 112 and the grooves 125 preciously controls the trajectory of the component bracket 12 to avoid direction offset.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A connecting structure, comprising:
a ball joint bracket comprising a ball joint; and
a component bracket defining a housing space;
wherein the ball joint is rotatably received in the housing space, at least one protrusion is located on a selection one of an inner wall of the housing space and a surface of the ball joint, at least one groove is located on the remaining one of the inner wall of the housing space and the surface of the ball joint, and the at least one protrusion is slidably limited in the at least one groove.

2. The connecting structure of claim 1, wherein the at least one protrusion comprises a plurality of first protrusions and a second protrusion, the at least one groove comprises a plurality of first grooves and a second groove, the first protrusions are slidably limited in the first grooves , and the second protrusion is slidably limited in the second groove.

3. The connecting structure of claim 2, wherein the protrusions are a selective one of a curved shape and a spherical shape, the first protrusions are located in the middle part of the ball joint, and the second protrusion is located in one end of the ball joint.

4. The connecting structure of claim 1, wherein the grooves each are a concave arc shaped structure.

5. The connecting structure of claim 1, wherein the housing space comprises a base and a plurality of flexible arms, the flexible arms are separated by gaps between the flexible arms, each of the plurality of the flexible arms comprises a thread portion, a stopper portion and a plurality of first grooves, and the second groove is located on the base.

6. The connecting structure of claim 5, wherein the thread portions of the flexible arms cooperatively define a cylindrical peripheral structure, the stopper portions protrude to the housing space.

7. The connecting structure of claim 6, wherein a nut is received in the cylindrical peripheral structure.

8. The connecting structure of claim 7, wherein the nut is hexagon nut.
